(19) United States
(12) Patent Application Publication
(10) Pub. No.: US 2012/0084112 A1
(43) Pub. Date: Apr. 5, 2012

(54) PROVIDING COMMUNITY FOR CUSTOMER QUESTIONS

(75) Inventors: Sugato Bagchi, White Plains, NY (US); Branimir K. Boguraev, Bedford, NY (US); Anthony T. Levas, Yorktown Heights, NY (US); Roberto Sicconi, Ridgefield, CT (US); Wlodek W. Zadrozny, Tarrytown, NY (US)

(73) Assignee: INTERNATIONAL BUSINESS MACHINES CORPORATION, Armonk, NY (US)

(21) Appl. No.: 13/244,430

(22) Filed: Sep. 24, 2011

Related U.S. Application Data
(60) Provisional application No. 61/386,024, filed on Sep. 24, 2010.

(51) Int. Cl. G06Q 10/06

(52) U.S. Cl. 705/7.14

(57) ABSTRACT

A system for providing community for customer questions receives a customer question. The customer question may be classified into a classification from a plurality of classifications categorizing whether a question is answerable, needs expert assistance, needs more information, or is not answerable. Based on the classification and one or more incentives, the question may be further routed to an appropriate community. The interactions with a customer in receiving and answering the customer question may be recorded.

### CROSS-REFERENCE TO RELATED APPLICATIONS

This application claims the benefit of U.S. Provisional Application No. 61/386,024, filed on Sep. 24, 2010, which is incorporated by reference herein in its entirety.

### FIELD

The present application relates generally to computers, and computer applications, and more particularly to artificial intelligence and natural language processing.

### BACKGROUND

Providing customer service is not an easy task. For example, The McKinsey Quarterly, in an article entitled Are you listening to your call center? (April 2002 by Raffaella Bianchi and Mauricio Janauskas) discusses some of the problems and organizational proposals to address them.

### BRIEF SUMMARY

A method for providing a community for customer questions, in one aspect, may include receiving a customer question. The method may further include invoking a question and answer processing module to automatically determine an answer to the customer question. The method may also include receiving an answer from the question and answer processing module with associated confidence level. The method may yet further include classifying the customer question based on the received answer and the associated confidence level. The classifying may include classifying the customer question as answerable if the associated confidence level meets a predetermined threshold. The classifying may also include classifying the customer question as needs expert assistance, if the associated confidence level does not meet the predetermined threshold and if it is determined that an expert's input is needed. The classifying may further include classifying the customer question as needs more information, if the associated confidence level does not meet the predetermined threshold and if it is determined that more information is needed from the customer. The method may further include selecting one or more expert and routing the customer question to the selected one or more experts if the customer question is classified as needs expert assistance and based on one or more program controlling incentives. The method may also include routing the customer question back to a customer if the customer question is classified as needs more information and providing a feedback to the customer as to the more information needed, wherein the more information received from the customer allows the question and answer processing module to provide an answer. The method may further include providing the answer received from the question and answer processing module to the customer if the customer question is classified as answerable. The method may also include providing the answer with help the selected one or more experts if the customer question is routed to the selected one or more experts.

A system for providing a community for customer questions, in one aspect, may include a communication and dialog module operable to receive a customer question. A question and answer processing module may be operable to execute on the processor and further operable to parse and produce a candidate answer to the customer question with associated confidence level. A business logic module operable to receive the candidate answer from the question and answer processing module with the associated confidence level, the business logic module further operable to classify the customer question based on the received answer and the associated confidence level. The classifying may include classifying the customer question as answerable if the associated confidence level meets a predetermined threshold. The classifying may also include classifying the customer question as needs expert assistance, if the associated confidence level does not meet the predetermined threshold and if it is determined that an expert's input is needed. The classifying may further include classifying the customer question as needs more information, if the associated confidence level does not meet the predetermined threshold and if it is determined that more information is needed from the customer. The business logic module may be further operable to select one or more experts and route the customer question to the selected one or more experts if the customer question is classified as needs expert assistance and based on one or more program controlling incentives. The business logic module may be further operable to route the customer question back to a customer if the customer question is classified as needs more information and provide a feedback to the customer as to what more information needed. The more information received from the customer may allow the question and answer processing module to provide an answer. The business logic module may be further operable to provide the answer received from the question and answer processing module to the customer if the customer question is classified as answerable. The business logic module may be further operable to provide the answer with help of the selected one or more experts if the customer question is routed to the selected one or more experts.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a diagram illustrating functional components which may provide a system for providing a community for customer questions in one embodiment of the present disclosure.

FIG. 2 is a diagram illustrating QA processing in one embodiment of the present disclosure.

FIG. 3 is a flow diagram illustrating a method for providing a community for customer questions in one embodiment of the present disclosure.

### DETAILED DESCRIPTION

We disclose a system and methodologies for providing community for customer care that, for example, travels alongside a customer. In one embodiment of the present disclosure, community for customer care that may be always available to a customer can be facilitated by an open domain question answering system and its use with messaging. A system for providing community for customer care may address in real time questions a customer can have about products and services, enable additional sales of products and services, and keep the relationship between the customer and the company strong. A system for providing community for customer care may leverage mobility of customer-owned devices (cell/smart-phone, car, portable connected electronics, and/or others) to provide ubiquitous and easy-to-access support, and semi-supervised community-based contributions to complement the official support knowledge base. A system for providing community for customer care may also function as customer support site that is equivalent of a social networking site.

In another aspect, we address the issue of managing customer calls to a company, identifying those calls that can be answered automatically and providing an environment for comprehensive customer care. This may be accomplished by leveraging the capabilities of a question answering system based on question and answer (QA) architecture (e.g., disclosed in the US patent publications 20090287678, 20090292687).

System and methodologies of the present disclosure in one embodiment may provide more efficient customer care and question answering, than existing systems such as those that utilize static or predefined patterns or databases or web pages (e.g., frequently asked questions (FAQ), A Web-Based Platform for User-Interactive Question-Answering) or even automated call centers. System and methodologies of the present disclosure in one embodiment need not be dependent on such predefined patterns, rather may be enabled to answer any type of questions about any type of domains. System and methodologies of the present disclosure in one embodiment further may enable automatic referring of customer questions to experts when needed and available, thereby preserving the quality of human-supported solutions at lower costs. System and methodologies of the present disclosure in one embodiment may be seamlessly integrated with other part of business, and provide ubiquitous quality customer care.

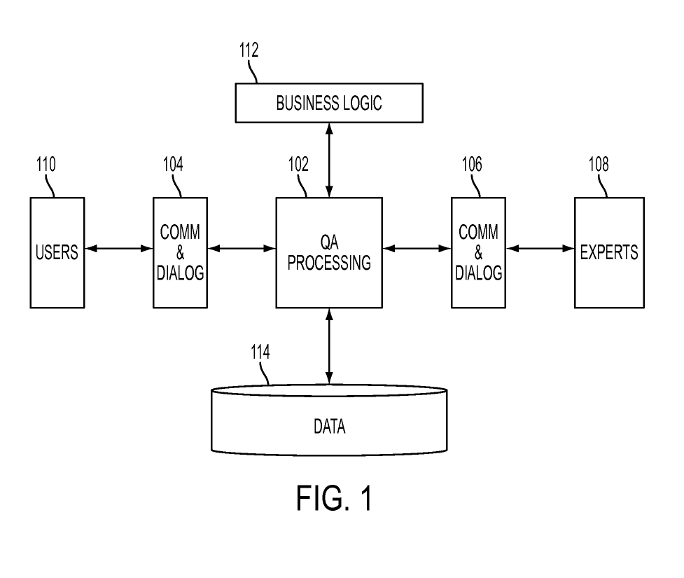

FIG. 1 is a diagram illustrating functional components for providing a community for customer questions in one embodiment of the present disclosure. A communication and dialog component or module (104, 106) may facilitate communication between users 104, experts 108 and a QA processing component 102. For instance, the communication and dialog component 104, 106 may send messages, received messages and adapt to one more devices for communications. The communication and dialog component 104, 106 further may ask questions to the QA processing component 102, users 104, and/or experts 108, and get answers from one or more of those components 102, 104, 108. Users 104 and experts 108 may be individuals or network of individuals. The communication and dialog component 104, 106 in one embodiment may include one or more components operable for providing communication capabilities, e.g., instant messaging, Twitter®, RSS feeds, blog systems and/or email, for instance, by users such as customers and employees using internet and mobile networks.

A business logic component 112 may supervise the processes and control incentives.

Business logic 112, in particular, may assign questions to experts or specify which experts to assign the questions, for instance, based on the experts' domain of expertise, e.g., by matching the topic of a question with the experts' descriptions of the competencies. Business logic 112 may also ensure that only the question requiring the expert's expertise would be answered by the expert, e.g., by utilizing the degree of difficulty of the questions, or utilizing a classifier that assigns it to the ‘expert answer required’ class. Controlling incentives may include determining whether or in which circumstances, questions should be assigned to experts. Incentives may be dynamic, where the different questions and different time of the days as well as business needs and possibly other factors, e.g., current and previous customer satisfaction statistics, determine the ‘payout’ to the expert, whether to engage an expert in answering the question.

In this way, employees (experts) or employee group (expert groups) are protected from answering questions that may be answered by others or more automated procedure. Thus, the methodology of the present disclosure may provide a broad coverage of the QA system, delivered confidence, and the monitoring of answers and their impact on business while at the same time minimizing expert involvement by directing questions to the correct channel equipped to answer the questions.

Business Logic may implement several functions and may comprise one or more of the following:

a. Align incentives with data from Answer Classification. For instance, answer results may be matched with incentives, e.g., incentives for employees and incentives for customers such as discounts. For example, employees can earn bonuses or titles such as “expert in X” by successfully answering questions. Customers can be offered discounts for switching to the next version of the product e.g. if the question is related to the prior version of the product.
b. Make priority to answer questions/resolve problems when answers are needed, and balance this need with protection of experts' time using the capabilities of the question answering system to answer more routine questions and provide confidences for its answers. For example, which answers should be answered by an expert or automatically by a computer or like automated system, may be prioritized based on criteria such as the availability of resources, confidence level of an automatically generated answer, expert information, and/or others. As another example, if multiple questions require the expertise of the same expert, those with automatically generated answers having higher confidence level from less urgent customers can be attempted to be answered automatically, while the expert answers questions from more urgent customers.
c. Track availability of employees and experts to answer questions. Business Logic may also use question classification, QA System confidence, and expert information to route the questions. For example, if it is determined that an expert to answer a question is not available, the question may be routed to an automated QA system, for example, if the QA system is able to provide an answer with an acceptable confidence level or score (e.g., a threshold level). As another example, if an expert is available to answer a question and if an automated QA system could not produce an answer with an acceptable confidence level (e.g., meeting a predetermined threshold level), the question may be routed to the available expert. The routing may also performed based on the question classification. Using the above example, if a question is classified as a procedural question (a question asking how to do something), the question may be routed to an available expert. Any combination of criteria may be used to determine the routing.
d. Organize ad hoc groups to solve problems/answer questions based on type of question/problem, expertise, and availability.
e. Connect with dynamic pricing and/or other business applications if needed. e.g., supply chain application for determining what products are available and when. For instance, questions may refer to availability of products, in which case, the answers may be provided by information from a supply chain application. As another example, by connecting to such dynamic pricing, supply chain, and/or other business applications, recommendations can be made to the customers inquiring about a product/service, of another related product/service.
f. Identification of valuable customers, e.g., to estimate the value of providing an answer.
g. Use business intelligence on competitors, web reviews of products and others to enhance the quality of answers and effectiveness of offerings (e.g., discounts).
h. Feed to other reporting functions such as dashboards and/or others.

Data 114 may include customer related data such as but not limited to, what the customer have (e.g., products, services, etc.), the customer roles, what is known about them, and others. Data 114 may also include expert data such as but not limited to, what they know, what is known about them, etc. Data 114 may further include historical data such as but not limited to histories of interactions with the customers and others. Data 114 may still yet include technical data such as but not limited to, format of data, e.g., text, structured, video, images, and others. Data 114 may include a database/corpus of documents such as manuals, previously solved customer problems, and other information. A database/corpus of customer specific information may include products owned, type of equipment, services subscribed to, typical usage patterns, and/or others.

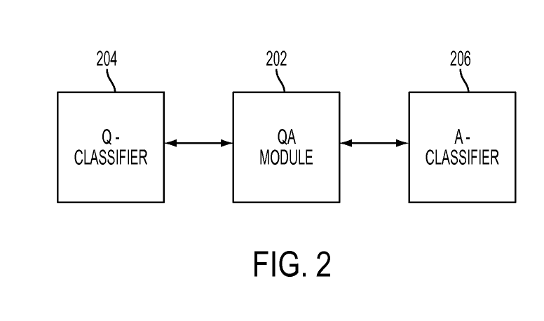

FIG. 2 is a diagram illustrating Question and Answer processing in one embodiment of the present disclosure. The QA module 202 may receive a question, process it and produce one or more candidate answers, e.g., ranked and scored. The questions may be received in natural language form or other format. The QA module 202 may produce metadata describing how the answer was arrived at. The QA module 202 may include question answering system, which generally utilizes natural language processing, machine learning and/or data mining and other technologies to process the questions and produce answers, for example with confidence level or score that measures the accuracy or correctness of the produced answers. An example of a question answering system is described in Building Watson: An Overview of the DeepQA Project by David Ferrucci, Eric Brown, Jennifer Chu-Carroll, James Fan, David Gondek, Aditya A. Kalyanpur, Adam Lally, J. William Murdock, Eric Nyberg, John Prager, Nico Schlaefer, and Chris Welty, 2010, Association for the Advancement of Artificial Intelligence, pages 59-79.

A Q-Classifier (Question Classifier) module or functional component 204 may classify or categorize a question into different classifications or groups. For instance, classifications may include, but not limited to, “answerable”, “need expert assistance”, “get more data”, “not answerable”. A question may be classified as “answerable”, if it falls into a predefined category, for instance, refers to particular products, and based on prior system behavior the classifier assigns high probability that an answer can be determined from existing data or information with a predetermined degree of certainty. Machine learning statistical classification methods or other methodologies may be used for such classification. In one embodiment of a methodology of the present disclosure, a classifier may be built by applying one or more machine learning techniques to a small collection of human annotated questions, upon which the resulting classifier may be used to classify new, unseen questions, answers, or other documents.

A question may be classified as “need expert assistance”. A simple scenario for classifying a question into this category might be if previously answered questions with similar features as the current question required experts; then the current question should also be classified into this category. Similarly, if a QA system could not come up with reasonable answers to a question, that question might be put it into “need expert assistance” class, for instance, if there exists an expert on the topic of the question.

A question may be classified as “get more data”, if it is determined that additional information is needed in order to answer the question. For example, the question from a customer may be “can you confirm what the sales representative told me yesterday?” Such a question would need additional information such as what was told, the name of the sales representative the customer is referring to.

A question may be classified as “not answerable”. For example, questions which ask for confidential information may be classified into this class. Questions may be classified into this class, for instance, based on a set of predefined rules. For example, the rules may specify types of confidential information, a class of question not answerable in principle, for instance, because of their open ended character or abstractness (e.g., ‘what's the meaning of life?’).

In addition, the question may be placed into one or more technical classes that can provide additional constraints on the answers from the question answering system examples of which are described as follows.

### Process Class

An answer to a question in this class may entail outlining and/or enumerating steps in a procedure. Example questions may be explicitly procedural, such as “How can I unlock or reset my XYZ domain account?”, “How do I extract data from ABC mail messages and export them as a spreadsheet or table?” Questions in this class may be implicitly procedural, such as “Is there a way to connect a XYZ smartphone via wifi if you are on an AAA site using a BBB account?”, “Is there a way to limit access to just one child page within DEF Connections Wiki or is all or nothing?”. These questions may appear like a “yes/no” questions, but answering just with a “yes” is not satisfactory; there is an implicit ‘contract’ in the Q/A exchange which expects an elaboration, taking the shape of a procedure outline.

### Explanation Class

An answer to a question in this class is typically a paragraph (or more) long passage outlining essential characteristics of what the question asks about. Example questions may be “What does the pop-up box labeled, ‘Overflow’ in XYZ user interface software mean?”, “Why is my ABC e-mail account usage not dropped even though I have cleaned up my local replica?”, “Whenever I try to acquire more than 1 IP, I get disconnected from the network. What's going on?”

### Yes/No Class

An answer to a question in this class is a “yes” or a “no”. Example questions may be “Is there an alternative to ABC e-mail tool for AAA company Email?”, “Does Answers support other languages? (other than English)?”, “Is ABC the preferred collaboration tool to work with external partners on a project?”. Note that some Yes/No questions may be hidden Explanation ones, e.g., “Can AAA company's software group sell products built on B software?”

### Troubleshooting Class

Questions in this class may be similar to the procedural questions, but may start with a premise that something is wrong (on the side of whoever is asking the question). Example questions in this class may be “XYZ software is hung. How do I kill it?”, “I accidentally pressed a XYZ user interface button and my screen rotated 90 (or 180) degrees! How do I get it back?”, “There's a card reader that's broken in my building who should I tell to get it fixed?”

### Factoids Class

Example questions in this class may be “What is the most popular XYZ development tool in use in ABC Company currently?”, “Which museums have free admissions?”, “Which XYZ eclipse plugin should I use?”. A sub-category of factoids may ask for or may be appropriate to give an answer in the form of a URL. Examples of such questions may include “Is there somewhere on the XYZ network where people share XYZ-specific greasemonkey scripts?”, “Where can I download the latest version of XYZ for the ABC computer?”, “Free w3 webpage metrics (hit counter)?”

### Misc Class

Questions in this class may include meta-questions such as “Why did the question I asked in here disappeared?”. Questions in this class may be philosophical questions such as “What makes a great answer to a question?”. Questions in this class may be subjective questions such as “Does everyone love Answers as much as I do?????”

An answer-classifier (A-classifier) 206 may classify the answers. Answer classification may include two or more classes according to several dimensions. For example, answers may be classified as “full answer”, “partial answer”, or “no answer”. The three may be seen from user or machine perspective, e.g., it is possible that a machine can classify the answer as complete, and the while the user might take it as “no answer”. It is also possible the machine will classify the answer as incomplete, e.g., when the user is asking a “how do I” (process) question, and the answer, say a pointer to a web page, does not contain metadata indicating it is a process, yet it is satisfying to the user. Such conflicting classification may be resolved according to an algorithm or weighting. Answers may be also classified by topics and/or semantic classes such as product topics, help desk topics, and others. Answers may be also classified as expert provided answer, fully automated answer (e.g., machine provided the answer without human help), or semi-automated answer (e.g., machine and human input utilized to derive the answer). Answers may be also classified by impact on customer satisfaction, and subsequent customer behavior, e.g., what was the history leading to the question, what was subsequent behavior, e.g., did the customer make purchases after getting the answer. Other answer classifications are possible.

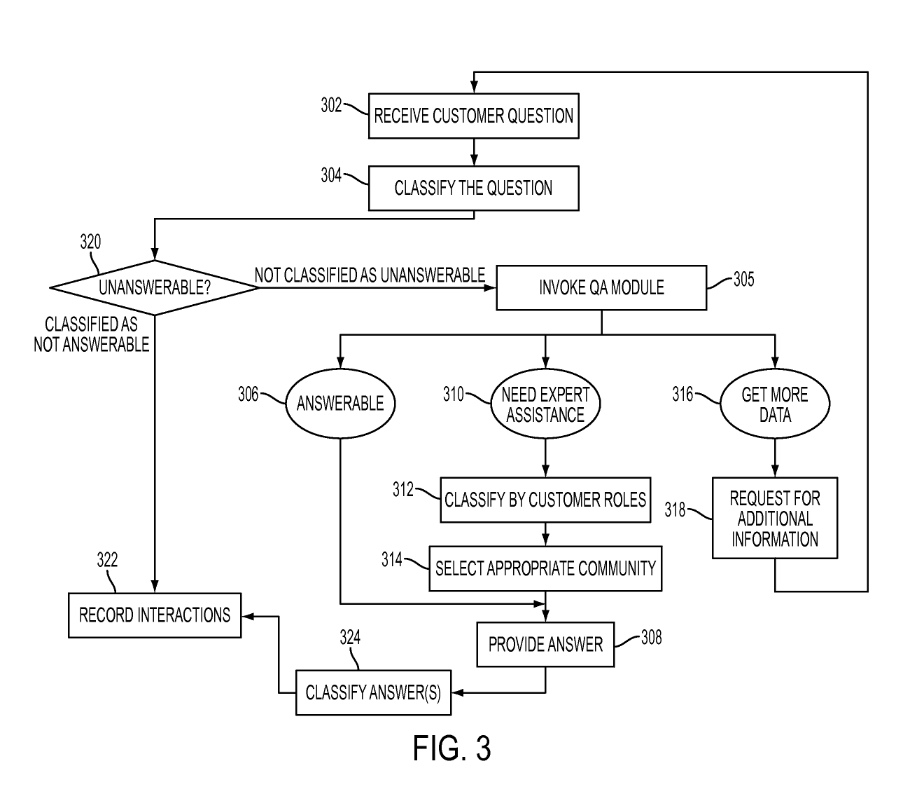

FIG. 3 is a flow diagram illustrating a method for providing a community for customer questions in one embodiment of the present disclosure. At 302, customer's question may be received. A customer may ask a question, for instance, using any access point such as instant messaging (IM), computer electronic mail (email), web interface, social networking sites, blog sites, technical forum, and/or others. At 304, the question is classified using customer specific information into a class. A question classifier may classify the question into a “not answerable class”, for instance, based on machine learning. At 320, if the question is determined to be “not answerable”, the customer may be notified and further a reason may be given for not answering the questions. At 322, the interaction with the customer is recorded. The classification at 304 may be performed automatically by a classification module, for instance, based on prior knowledge and/or machine learning. The classification at 304 may be performed before the question is submitted to a question and answering module. In another embodiment, the classification at 304 may be omitted, in which case, whether the question is unanswerable may be determined from the answer and confidence level associated with the answer received from a question and answering module.

At 305, a question and answering module is invoked with the question in order to receive an answer. The question and answering module may provide an answer, or require more information, for instance, from an expert or more information from the customer. In one embodiment of the present disclosure, the response from the question and answering module may be used to further classify the question. For instance, if the question and answering module answered the question the question is classified as “answerable.” If the question and answering module required more information and if it is determined that information should come from an expert, the question is classified as “need expert assistance.” If the question and answering module required more information about the question, the question is classified as “get more data”, and specific questions might be directed to the user. Example techniques that a question and answering module may use to determine and return such different responses to the questions are described in co-owned co-pending U.S. patent application Ser. No. ______ (Atttorney Docket YOR920110333US1) by Barborak et al. and entitled, “A Method for Utilizing Failures In Question And Answer System Responses To Enhance The Accuracy Of Question And Answer System”, which disclosure is incorporated herein by reference in its entirety.

At 306, if it is determined that the question is “answerable”, an answer is provided at 308, for instance, either automatically or by a call center personnel. At 316, if the question is classified as, “get more data”, then an elaboration is requested at 318, possibly confirming additional data points, and restarting the answering process. If the question is classified as, “need expert assistance” at 310, the question is further classified by, e.g., by customer roles (a manager and/or a technical person) at 312 who may be able to address the questions. At 314, appropriate support community is chosen to answer the question (e.g., sales, technical, and/or others). At 308, an answer may be provided by a member of the community. At 322, the interaction with the customer is recorded. For example, the question received from the customer and the resulting one or more answers provided to the customers may be recorded, the classification of the question may be also. The recorded interactions may be mined for business insight. In addition, the answers may be classified at 324, for instance, based on the types of questions and the classes of the questions.

In one embodiment, a business logic module may determine the classification at 306, 310 and 316 based on the answer and the associated confidence level or score received from the question and answering module, and also based on one or more predetermined criteria, for instance, controlling organization incentives and/or availability of experts.

Further, successfully delivered answers can be used to classify customer questions. The role and/or title or an expert answering a question can be used for the same purpose. The recorded interactions (also referred to as data log) can be used, e.g., to improve product interface or documentation. Similarly, a record or log of questions that cannot be confidently answered by a system can be used for understanding the data either missing in the QA system or inappropriately adapted.

In one aspect, the methodology of the present disclosure may be enabled via the internet, kiosks, and/or mobile devices, and others, and may be enabled to provide product support for all kinds of users. The call volume to call centers may be reduced; by identifying and transferring the “need expert assistance” type problems to appropriate class of support community (management, sales, technical support), the methodology of the present disclosure may provide better customer care, and alert the appropriate group in real time about emerging problems. The classification capability ensures that experts will not be answering routine questions. In another aspect, the question answering system of the present disclosure may be automatic and all conversations recorded, providing an opportunity to use appropriate sets of incentives to ensure all questions are answered. A combination of information mining capability and the priming by several employee groups answering questions allows a company to address the underlying organizational and production issues. Being in close contact with a customer also provides an opportunity for additional sales.

The disclosed system in one embodiment can leverage contextual information. For example, the system knows what the customer has, e.g., what products, and knows the type of knowledge, e.g., technical vs. business, typical usage scenarios and prior problems, whether the problems were successfully addressed or not. An appropriate credit recognition system may facilitate establishing reliability ranks for information and individuals that contributed responses to the system, improving on the official knowledge base. By scanning and automatically classifying content across various communication media (email, IM, social networking, blogs, others) the methodology of the present disclosure may provide a unified point of entry for customer support, customer satisfaction analysis and trends monitoring. A methodology of the present disclosure in one embodiment may build unsupervised profiles of customer preferences, opening up to targeted advertisement provided with the responses to customer questions.

Possible applications of the methodologies and/or system of the present disclosure may include, but not limited to, software sales, medical equipment sales and support, services sales and contract support. The methodologies and/or system of the present disclosure in one embodiment may co-exists with a call center, and reduce the volume of routine and “expert” questions processed in such call center.

As disclosed herein, an automated question answering system unlimited in scope and/or domain may be integrated with enterprise data, employee expertise and communication networks, to better service the customers and optimize business goals.

Yet in another aspect, the question-answering as disclosed herein may be architected to include feedback loop with the questions and answers. For example, answered questions, customer feedback regarding the completeness of the answers, expert answers, and business impact can modify the parameters of the QA system by introducing new Q-A sets, allowing the QA system to change the parameters, aligning the answers with the business logic (e.g., the answers to questions about discounts and availability should incorporate business logic; answers to technical questions might suggest additional solutions available at certain price points). The organization of the whole system may be improved due to alignment of business logic with the behavior of the QA-system. For example, the change in confidences and coverage of the QA system changes how experts are aligned with questions and/or change incentives, e.g., more revenue or profit for incentives to answer questions about a new topic.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The systems and methodologies of the present disclosure may be carried out or executed in a computer system that includes a processing unit, which houses one or more processors and/or cores, memory and other systems components (not shown expressly in the drawing) that implement a computer processing system, or computer that may execute a computer program product. The computer program product may comprise media, for example a hard disk, a compact storage medium such as a compact disc, or other storage devices, which may be read by the processing unit by any techniques known or will be known to the skilled artisan for providing the computer program product to the processing system for execution.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer processing system that carries out the system and method of the present disclosure may also include a display device such as a monitor or display screen for presenting output displays and providing a display through which the user may input data and interact with the processing system, for instance, in cooperation with input devices such as the keyboard and mouse device or pointing device. The computer processing system may be also connected or coupled to one or more peripheral devices such as the printer, scanner, speaker, and any other devices, directly or via remote connections. The computer processing system may be connected or coupled to one or more other processing systems such as a server, other remote computer processing system, network storage devices, via any one or more of a local Ethernet, WAN connection, Internet, etc. or via any other networking methodologies that connect different computing systems and allow them to communicate with one another. The various functionalities and modules of the systems and methods of the present disclosure may be implemented or carried out distributedly on different processing systems or on any single platform, for instance, accessing data stored locally or distributedly on the network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method for providing a community for customer questions, comprising:
receiving a customer question;
invoking a question and answer processing module to automatically determine an answer to the customer question;
receiving an answer from the question and answer processing module with associated confidence level;
classifying the customer question based on the received answer and the associated confidence level, wherein the classifying includes at least,
classifying the customer question as answerable if the associated confidence level meets a predetermined threshold;
classifying the customer question as needs expert assistance, if the associated confidence level does not meet the predetermined threshold and if it is determined that an expert's input is needed;
classifying the customer question as needs more information, if the associated confidence level does not meet the predetermined threshold and if it is determined that more information is needed from the customer;
selecting one or more expert and routing the customer question to the selected one or more experts if the customer question is classified as needs expert assistance and based on one or more program controlling incentives;
routing the customer question back to a customer if the customer question is classified as needs more information and providing a feedback to the customer as to the more information needed, wherein the more information received from the customer allows the question and answer processing module to provide an answer;
providing the answer received from the question and answer processing module to the customer if the customer question is classified as answerable; and
providing the answer with help of the selected one or more experts if the customer question is routed to the selected one or more experts.

2. The method of claim 1, further including classifying the customer question into whether the customer question is unanswerable, before invoking the question and answer processing module, based on prior knowledge that a type of the customer question falls into an unanswerable category, and if the customer question is determined to be unanswerable, notifying the customer, and if the customer question is determined to be answerable, proceeding with the invoking the question and answer processing module step.

3. The method of claim 1, further including recording the customer questions, interactions with the customer and information from the question and answering processing module.

4. The method of claim 3, wherein the recording is mined for improving customer service.

5. The method of claim 1, wherein the customer question is further classified into sub-classes.

6. The method of claim 4, wherein the sub-classes classify the customer question as to whether an answer to the customer question is procedural, explanation, a yes or no, troubleshooting, factoids, or miscellaneous.

7. The method of claim 1, wherein a call center operator receives the customer question.

8. The method of claim 1, wherein the customer question is received via e-mail, instant messaging, social networking site, blog, or combinations thereof.

9. A computer readable storage medium storing a program of instructions executable by a machine to perform a method of providing a community for customer questions, comprising:
receiving a customer question;
invoking a question and answer processing module to automatically determine an answer to the customer question;
receiving an answer from the question and answer processing module with associated confidence level;
classifying the customer question based on the received answer and the associated confidence level, wherein the classifying includes at least,
classifying the customer question as answerable if the associated confidence level meets a predetermined threshold;
classifying the customer question as needs expert assistance, if the associated confidence level does not meet the predetermined threshold and if it is determined that an expert's input is needed;
classifying the customer question as needs more information, if the associated confidence level does not meet the predetermined threshold and if it is determined that more information is needed from the customer;
selecting one or more experts and routing the customer question to the selected one or more experts if the customer question is classified as needs expert assistance and based on one or more program controlling incentives;
routing the customer question back to a customer if the customer question is classified as needs more information, and providing a feedback to the customer as to the more information needed, wherein the more information received from the customer allows the question and answer processing module to provide an answer;
providing the answer received from the question and answer processing module to the customer if the customer question is classified as answerable; and
providing the answer with help of the selected one or more experts if the customer question is routed to the selected one or more experts.

10. The computer readable storage medium of claim 9, further including classifying the customer question into whether the customer question is unanswerable, before invoking the question and answer processing module, based on prior knowledge that a type of the customer question falls into an unanswerable category, and if the customer question is determined to be unanswerable, notifying the customer, and if the customer question is determined to be answerable, proceeding with the invoking the question and answer processing module step.

11. The computer readable storage medium of claim 9, further including recording the customer questions, interactions with the customer and information from the question and answering processing module.

12. The computer readable storage medium of claim 11, wherein the recording is mined for improving customer service.

13. The computer readable storage medium of claim 9, wherein the customer question is further classified into sub-classes.

14. The computer readable storage medium of claim 13, wherein the sub-classes classify the customer question as to whether an answer to the customer question is procedural, explanation, a yes or no, troubleshooting, factoids, or miscellaneous.

15. The computer readable storage medium of claim 9, wherein a call center operator receives the customer question.

16. The computer readable storage medium of claim 9, wherein the customer question is received via e-mail, instant messaging, social networking site, blog, or combinations thereof.

17. A system for providing a community for customer questions, comprising:
a processor;
a communication and dialog module operable to receive a customer question;
a question and answer processing module operable to execute on the processor and further operable to parse and produce a candidate answer to the customer question with associated confidence level;
a business logic module operable to receive the candidate answer from the question and answer processing module with the associated confidence level, the business logic module further operable to classify the customer question based on the received answer and the associated confidence level, wherein the classifying includes at least,
classifying the customer question as answerable if the associated confidence level meets a predetermined threshold;
classifying the customer question as needs expert assistance, if the associated confidence level does not meet the predetermined threshold and if it is determined that an expert's input is needed;
classifying the customer question as needs more information, if the associated confidence level does not meet the predetermined threshold and if it is determined that more information is needed from the customer;
the business logic module further operable to select one or more experts and route the customer question to the selected one or more experts if the customer question is classified as needs expert assistance and based on one or more program controlling incentives, the business logic module further operable to route the customer question back to a customer if the customer question is classified as needs more information and provide a feedback to the customer as to what more information needed, wherein the more information received from the customer allows the question and answer processing module to provide an answer, the business logic module further operable to provide the answer received from the question and answer processing module to the customer if the customer question is classified as answerable, and the business logic module further operable to provide the answer with help of the selected one or more experts if the customer question is routed to the selected one or more experts.

18. The system of claim 17, further including:
a classification module operable to classify the customer question into whether the customer question is unanswerable, before submitting the customer question to the question and answer processing module, based on prior knowledge that a type of the customer question falls into an unanswerable category, wherein if the customer question is determined to be unanswerable, the customer is notified, and if the customer question is determined to be answerable, the customer question is submitted to the question and answer processing module.

19. The system of claim 17, wherein the customer questions, interactions with the customer and information from the question and answering processing module are recorded.

20. The system of claim 19, wherein the recording is mined for improving customer service.

21. The system of claim 17, wherein the customer question is further classified into sub-classes.

22. The system of claim 21, wherein the sub-classes classify the customer question as to whether an answer to the customer question is procedural, explanation, a yes or no, troubleshooting, factoids, or miscellaneous.

23. The system of claim 17, wherein a call center operator receives the customer question.

24. The system of claim 17, wherein the customer question is received via e-mail, instant messaging, social networking site, blog, or combinations thereof.
